(19) United States
(12) Patent Application Publication
(10) Pub. No.: US 2025/0245490 A1
(43) Pub. Date: Jul. 31, 2025

(54) CONVOLUTION OPERATION INSTRUCTION GENERATION DEVICE, CONVOLUTION OPERATION METHOD, AND INTELLIGENCE PROCESSING UNIT

(71) Applicant: SigmaStar Technology Ltd., Xiamen (CN)

(72) Inventor: Yong Sheng Chen, Shanghai (CN)

(21) Appl. No.: 18/971,036

(22) Filed: Dec. 6, 2024

(30) Foreign Application Priority Data
Jan. 31, 2024 (CN) 202410137226.X

(51) Int. Cl. G06N 3/0464

(52) U.S. Cl. CPC G06N 3/0464

(57) ABSTRACT

A convolution operation instruction generation device generates a second convolution operation instruction according to a first convolution operation instruction that is used to perform a two-dimensional convolution operation on a first input tensor and a first weight. The second convolution operation instruction includes a three-dimensional (3D) convolution operator and is executed by an intelligence processing unit that includes a storage device and a computing circuit. The computing circuit accesses the storage device in units of Y elements. The convolution operation instruction generation device generates a second weight of the 3D convolution operator and determines the size, a second stride, and a padding value of a third dimension of the second weight based on Y, the size of a first dimension of the first weight, the size of a second dimension of the first weight, a dilation coefficient and first stride of the first dimension, and the first weight.

This application claims the benefit of China application Serial No. 202410137226.X filed on Jan. 31, 2024, the subject matter of which is incorporated herein by reference.

### BACKGROUND OF THE INVENTION

### 1. Field of the Invention

The present invention generally relates to neural networks, and, more particularly, to convolution operations of neural networks.

### 2. Description of Related Art

Reference is made to FIG. 1, which is a schematic diagram of the input tensor for conventional two-dimensional (2D) convolution operations. The height (H) and width (W) of the input tensor are 5 and 10, respectively, and “Ci” represents the number of channels. FIG. 2A and FIG. 2B show the arrangement of the input tensor in the first cache and the second cache, respectively. Generally, the capacity of the first cache is larger than that of the second cache, while the second cache is closer to the computing circuit of the electronic device (e.g., the computing circuit of an intelligence processing unit (IPU)) and operates faster than the first cache. Since the first cache usually cannot store the complete input tensor, the input tensor is divided into several tiles, and FIG. 2A shows only one of the tiles. As shown in FIG. 2A, multiple cuboids (each containing Ci elements) of the tile are arranged in the first cache in sequence. When the tile is stored in the second cache (as shown in FIG. 2B), a row contains only one cuboid (where “x” means no data, that is, a row of the second cache contains only one valid data, and a valid data contains Ci elements).

Reference is made to FIG. 3, which is a schematic diagram of the weights of a 2D convolution operation. A 2D weight KB_2D contains multiple convolution kernels. FIG. 3 shows 32 convolution kernels (KB_2D_1, KB_2D_2, KB_2D_3, . . . , KB_2D_31, and KB_2D_32), each of which contains 9 cuboids (e.g., the convolution kernel KB_2D_1 contains 9 cuboids: k11, k12, k13, k14, k15, k16, k17, k18, and k19, the convolution kernel KB_2D_2 contains 9 cuboids: k21, k22, k23, k24, k25, k26, k27, k28, and k29, and so on), and each cuboid contains Ci elements. FIG. 4A and FIG. 4B show the arrangement of the 2D weights in the first cache and the second cache, respectively. FIG. 4A shows that the first cache stores multiple cuboids of multiple convolution kernels in sequence, while FIG. 4B shows that a row of the second cache contains only one cuboid (where a cuboid contains Ci elements).

Reference is made to FIG. 2B and FIG. 4B. The computing circuit accesses the second cache on a row-by-row basis (i.e., Y elements are read each time). Since each row contains only one valid data (Ci elements), the effective utilization rate of the computing circuit for the second cache is Ci/Y. Since a too small Y value limits the computing capability of the convolution engine of the computing circuit or causes a sharp increase in hardware cost, it is difficult to improve the effective utilization rate of the computing circuit for the second cache by reducing the Y value. As a result, the smaller the number of channels Ci, the worse the performance of the computing circuit and the electronic components using the computing circuit.

### SUMMARY OF THE INVENTION

In view of the issues of the prior art, an object of the present invention is to provide a convolution operation instruction generation device, a convolution operation method, and an intelligence processing unit (IPU), so as to make an improvement to the prior art.

According to one aspect of the present invention, a convolution operation instruction generation device is provided. The convolution operation instruction generation device generates a second convolution operation instruction based on a first convolution operation instruction. The first convolution operation instruction is for performing a two-dimensional (2D) convolution operation on a first input tensor and a first weight. The second convolution operation instruction includes a three-dimensional (3D) convolution operator and is executed by an IPU including a storage device and a computing circuit. The computing circuit accesses the storage device in units of Y elements. The convolution operation instruction generation device includes a memory and a processor. The memory is configured to store a plurality of program codes and/or program instructions. The processor is coupled to the memory and configured to execute the plurality of program codes and/or program instructions to perform following steps: (A) calculating a multiple according to Y, a size of a first dimension of the first weight, a size of a second dimension of the first weight, a dilation coefficient of the first dimension, and a first stride of the first dimension; (B) generating a second weight of the 3D convolution operator according to the multiple and the first weight; (C) generating a plurality of second biases of the second weight according to the multiple and a plurality of first biases of the first weight; and (D) determining a size of a third dimension of the second weight, a second stride of the third dimension, and a padding value of the third dimension according to a size of the first dimension, the multiple, the first stride, and the dilation coefficient.

According to another aspect of the present invention, a convolution operation method is provided. The convolution operation method is executed by an IPU including a first storage device, a second storage device, and a computing circuit. The computing circuit accesses the second storage device in units of Y elements and performs a 3D convolution operation on an input tensor and a 3D weight. A size of a first dimension of the input tensor is a value. The convolution operation method includes the following steps: reading a part of the input tensor and a part of the 3D weight from the first storage device, and writing the part of the input tensor and the part of the 3D weight into the second storage device, wherein an effective data amount of Y consecutive elements in the second storage device is greater than the value; reading the part of the input tensor and the part of the 3D weight from the second storage device, and performing the 3D convolution operation to generate an output tensor; writing the output tensor to the second storage device; and reading the output tensor from the second storage device, and writing the output tensor into the first storage device.

According to still another aspect of the present invention, an IPU is provided. The IPU performs a 3D convolution operation on an input tensor and a 3D weight. A size of a first dimension of the input tensor is a value. The IPU includes a first storage device, a second storage device, a direct memory access (DMA) circuit, and a computing circuit. The first storage device is configured to store a part of the input tensor and a part of the 3D weight. The DMA circuit is coupled to the first storage device and the second storage device and configured to read the part of the input tensor and the part of the 3D weight from the first storage device and write the part of the input tensor and the part of the 3D weight into the second storage device. An effective data amount of Y consecutive elements in the second storage device is greater than the value. The computing circuit is coupled to the second storage device and configured to perform the following steps: reading the part of the input tensor and the part of the 3D weight from the second storage device, and performing the 3D convolution operation to generate an output tensor; and writing the output tensor to the second storage device. The DMA circuit further reads the output tensor from the second storage device and writes the output tensor into the first storage device.

The technical means embodied in the embodiments of the present invention can solve at least one of the problems of the prior art. Therefore, compared to the prior art, the present invention can improve the performance of computing circuits and electronic devices.

These and other objectives of the present invention no doubt become obvious to those of ordinary skill in the art after reading the following detailed description of the preferred embodiments with reference to the various figures and drawings.

### BRIEF DESCRIPTION OF THE DRAWINGS

FIG. 1 is a schematic diagram of an input tensor of a conventional two-dimensional (2D) convolution operation.

FIG. 2A and FIG. 2B show the arrangement of the input tensor in the first cache and the second cache, respectively.

FIG. 3 is a schematic diagram of the weights of a conventional 2D convolution operation.

FIG. 4A shows the conventional arrangement of multiple convolution kernels in the first cache.

FIG. 4B shows the conventional arrangement of multiple convolution kernels in the second cache.

FIG. 5 is the flowchart of the generation method of the convolution operation instructions according to an embodiment of the present invention.

FIG. 6 is the functional block diagram of the convolution operation instruction generation device according to an embodiment of the present invention.

FIG. 7 is a flowchart of the convolution operation method according to an embodiment of the present invention.

FIG. 8 is a functional block diagram of an electronic device according to an embodiment of the present invention.

FIG. 9 is a schematic diagram of dilating convolution kernels according to the invention.

FIG. 10 shows M of the multiple dilated convolution kernels from FIG. 9.

FIG. 11 is a schematic diagram of the dilation of the biases of the convolution according to an embodiment of the present invention.

FIG. 12 is a schematic diagram of the convolution operation instruction conversion according to an embodiment of the present invention.

FIG. 13 is a schematic diagram of the arrangement of the input tensors of the three-dimensional (3D) convolution operation in the first cache according to the present invention.

FIG. 14 is a schematic diagram of the arrangement of the convolution kernels of the 3D convolution operation in the first cache according to the present invention.

FIG. 15 is a schematic diagram of the arrangement of the input tensors of the 3D convolution operation in the second cache according to the present invention.

FIG. 16 is a schematic diagram of the arrangement of the convolution kernels of the 3D convolution operation in the second cache according to the present invention.

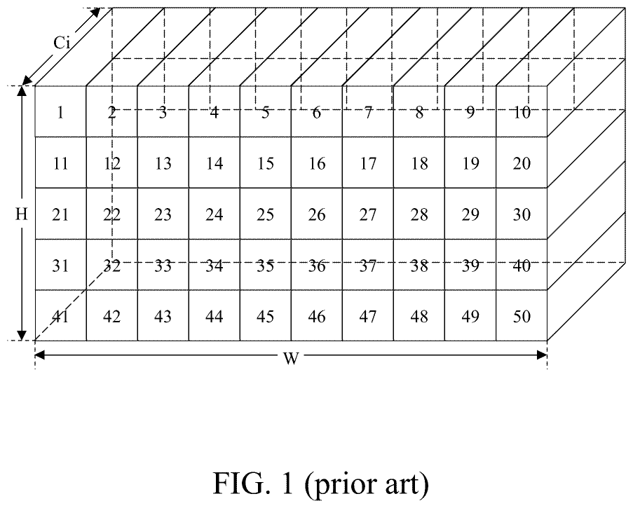

### DETAILED DESCRIPTION OF THE EMBODIMENTS

The following description is written by referring to terms of this technical field. If any term is defined in this specification, such term should be interpreted accordingly. In addition, the connection between objects or events in the below-described embodiments can be direct or indirect provided that these embodiments are practicable under such connection. Said “indirect” means that an intermediate object or a physical space exists between the objects, or an intermediate event or a time interval exists between the events.

The disclosure herein includes a convolution operation instruction generation device, a convolution operation method, and intelligence processing unit (IPU). On account of that some or all elements of the convolution operation instruction generation device and the IPU could be known, the detail of such elements is omitted provided that such detail has little to do with the features of this disclosure, and that this omission nowhere dissatisfies the specification and enablement requirements. Some or all of the processes of the convolution operation method may be implemented by software and/or firmware and can be performed by the IPU or its equivalent. A person having ordinary skill in the art can choose components or steps equivalent to those described in this specification to carry out the present invention, which means that the scope of this invention is not limited to the embodiments in the specification.

Since the three-dimensional (3D) convolution operation performs accumulation in any two dimensions (e.g., depth and channel, height and depth, or height and width), the present invention converts the two-dimensional (2D) convolution to the 3D convolution to implement the addition of any two dimensions in the original 2D convolution operation, thereby improving the effective utilization rate of the cache. For example, by converting the width dimension of the 2D convolution to the depth dimension of the 3D convolution, the width dimension and channel dimension of the original 2D convolution operation are accumulated. The following is a detailed explanation.

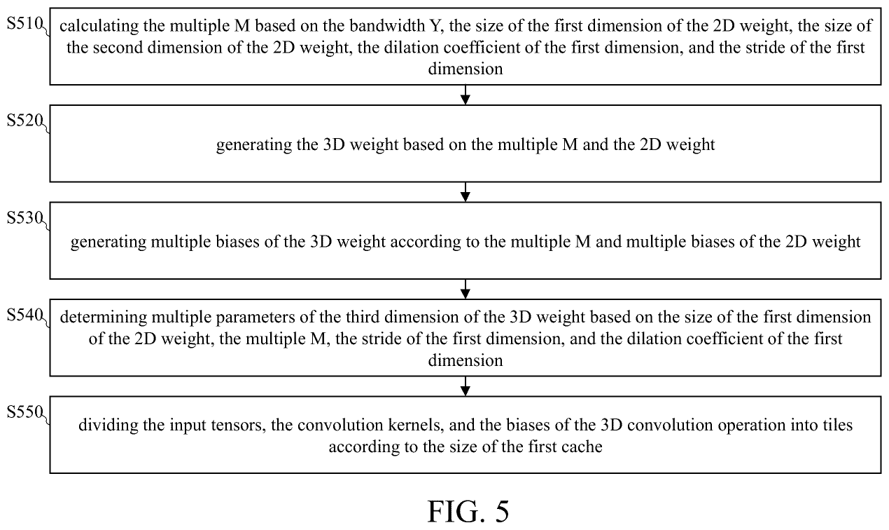

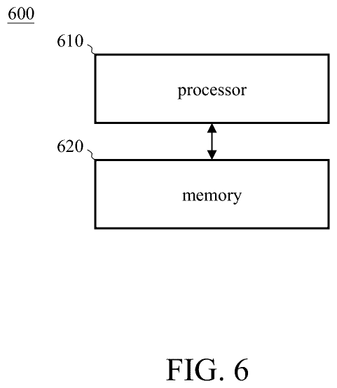

FIG. 5 is the flowchart of the generation method of the convolution operation instructions according to an embodiment of the present invention. FIG. 6 is the functional block diagram of the convolution operation instruction generation device according to an embodiment of the present invention. The flow of FIG. 5 may be executed by the convolution operation instruction generation device 600 of FIG. 6. The convolution operation instruction generation device 600 includes a processor 610 and a memory 620. In some embodiments, the convolution operation instruction generation device 600 may be a general-purpose computer.

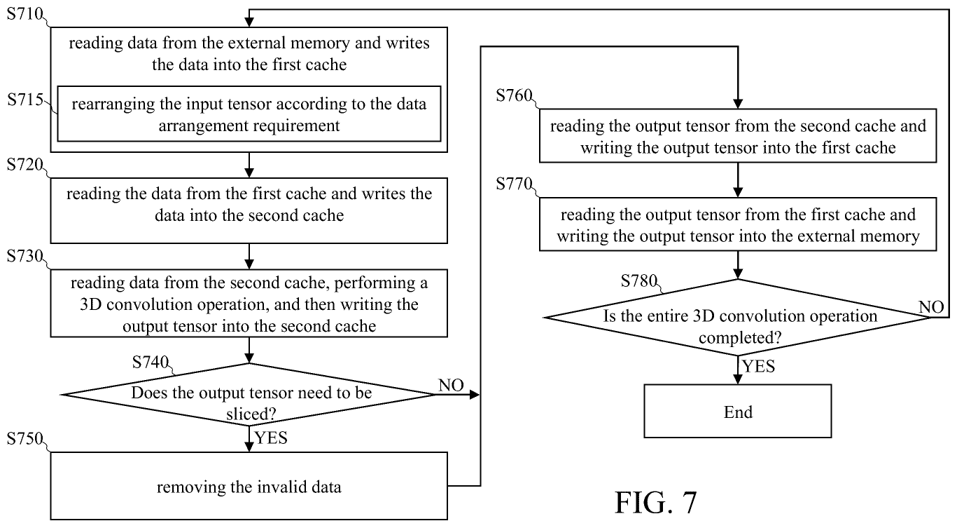

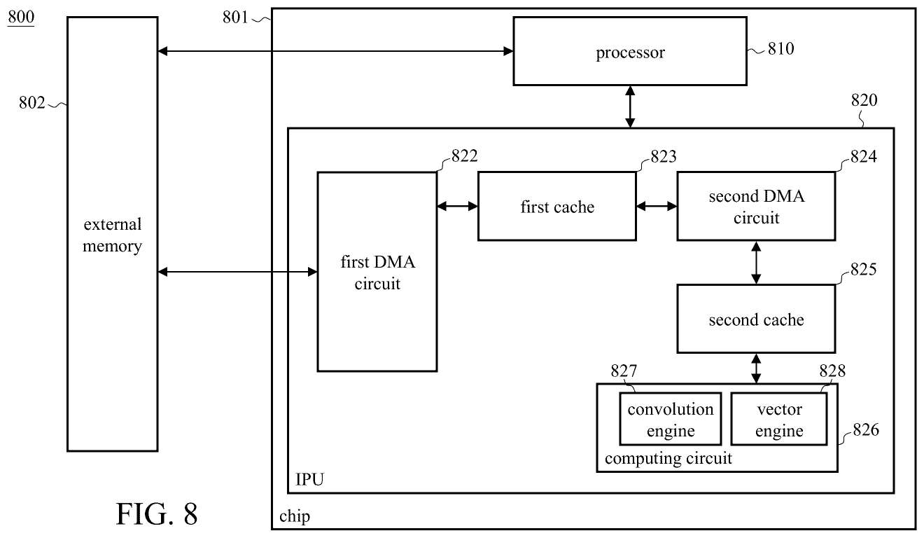

FIG. 7 is a flowchart of the convolution operation method according to an embodiment of the present invention. FIG. 8 is a functional block diagram of an electronic device according to an embodiment of the present invention. The flowchart of FIG. 7 may be executed by the electronic device 800 of FIG. 8. The electronic device 800 includes a chip 801 and an external memory 802. The external memory 802 is a type of storage device (which may be a volatile memory (e.g., a dynamic random access memory (DRAM))). The chip 801, which may be a chip with a specific function (e.g., an image processing chip), includes a processor 810 and an IPU 820. The processor 810 may be a circuit or electronic component with program execution capability, such as a central processing unit (CPU), a microprocessor, a microcontroller, a digital signal processor, an application specific integrated circuit (ASIC), or an equivalent circuit thereof. In some cases, the processor 810 cooperates with the IPU 820 to carry out the functions of the chip 801. More specifically, the processor 810 sends instructions (e.g., instructions related to convolution operations or vector operations) to the IPU 820, and the IPU 820 executes those instructions.

The IPU 820 includes a first direct memory access (DMA) circuit 822, a first cache (a type of storage device) 823, a second DMA circuit 824, a second cache 825, and a computing circuit 826. The computing circuit 826 includes a convolution engine 827 and a vector engine 828. The convolution engine 827 is configured to perform convolution operations, and the vector engine 828 is configured to perform vector operations. In the following discussion, the bandwidth of the second cache 825 is Y, which means that the computing circuit 826 accesses the second cache 825 in units of Y elements.

Reference is made to both FIG. 5 and FIG. 6. The processor 610 executes the flow of FIG. 5 by executing program codes or program instructions stored in the memory 620. The related equations are as shown in Equations (1) through (6). In the following example (used for illustration only and not to limit the scope of the claimed invention), the first dimension, the second dimension, and the third dimension are the width (Wk), the channel (Ci), and the depth (Dk), respectively.

$${Wk}^{′} = Wk + ( Wk - 1 ) \times ( dilation\_w - 1 ) \qquad ( 1 )$$

$$Y \geq [ {Wk}^{′} + t \times stride\_w ] \times Ci \qquad ( 2 )$$

$$2 \leq M \leq max ( t ) + 1 \qquad ( 3 )$$

$$Dk = {Wk}^{′} + ( M - 1 ) \times stride\_w \qquad ( 4 )$$

$$stride\_d = M \times stride\_w \qquad ( 5 )$$

$$padding\_d = ceil ( {W}_{i} / M ) \times M - {W}_{i} \qquad ( 6 )$$

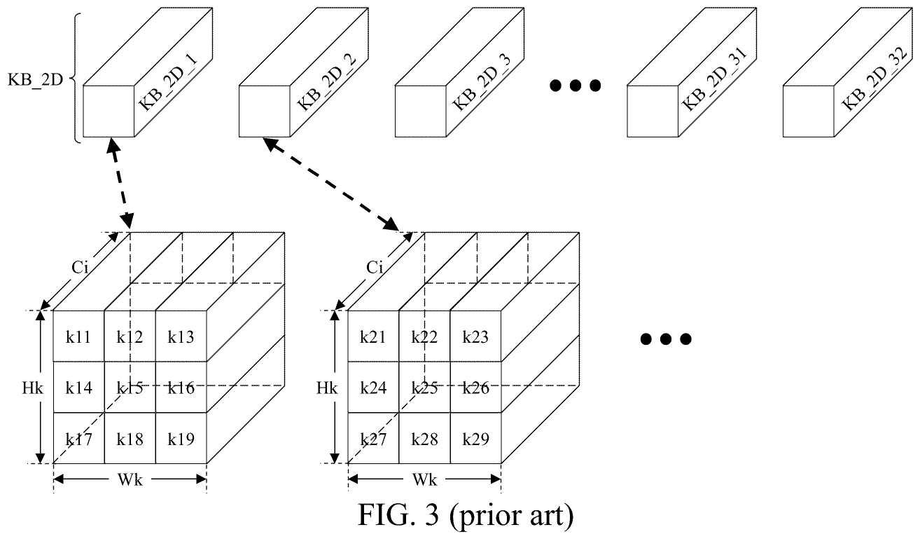

“Wk” represents the width of the 2D weight KB_2D (for example, the width Wk of the 2D weight KB_2D in FIG. 3 is 3). “Wk′” is the width of the dilated weight. “dilation_w” represents the dilation coefficient for width. “stride_w” represents the stride for width. “max(t)” represents the maximum value of the variable t. “stride_d” represents the stride for depth. “padding_d” represents the padding value for depth. “Wᵢ” represents the width of the input tensor. As can be seen from Equation (4), the width of the dilated weight (i.e., the 3D weight KB_3D, which will be discussed in detail below) is reflected in the dimension “Dk.”

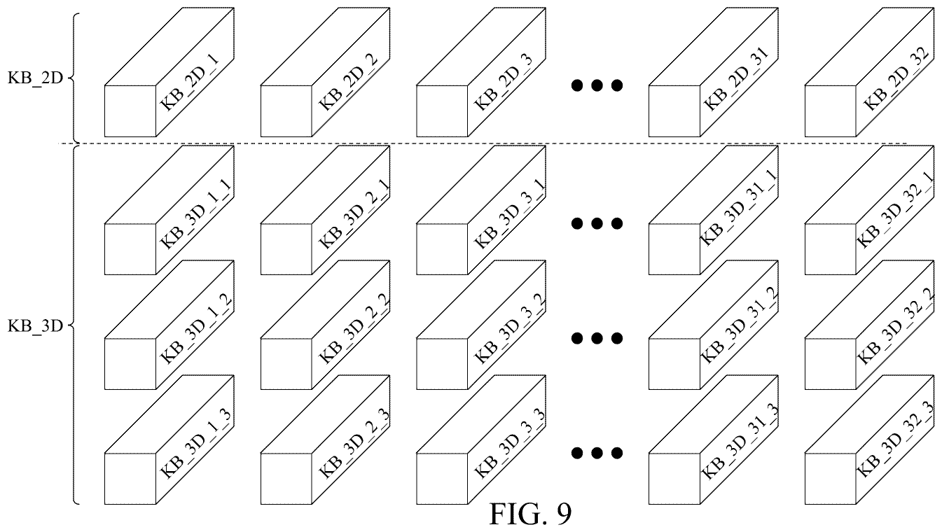

The flowchart of FIG. 5 includes the following steps.
Step S510: Calculating the multiple M based on the bandwidth Y, the size of the first dimension of the 2D weight KB_2D, the size of the second dimension of the 2D weight KB_2D, the dilation coefficient of the first dimension, and the stride of the first dimension. Step S510 may correspond to Equations (1) to (3). For example, if the bandwidth Y is 32, the number of channels Ci is 3, Wk is 3, dilation_w is 1, and stride_w is 1, then the maximum value of the variable t is 7, and the multiple M is between 2 and 8. In the following discussion, it is assumed that M is 3.
Step S520: Generating the 3D weight KB_3D based on the multiple M and the 2D weight KB_2D. Reference is made to FIG. 9, which is a schematic diagram of the dilation of a convolution kernel according to the present invention (where the 2D weight KB_2D is dilated into the 3D weight KB_3D). One convolution kernel of the 2D weight KB_2D is dilated into M convolution kernels of the 3D weight KB_3D. For example, the convolution kernel KB_2D_1 is dilated into the convolution kernels KB_3D_1_1, KB_3D_1_2, and KB_3D_1_3. In the example of FIG. 9, the value of M (which is 3) and the number of convolution kernels of the 2D weight KB_2D (which is 32) are for illustrative purposes only and not a limitation of the scope of the invention.

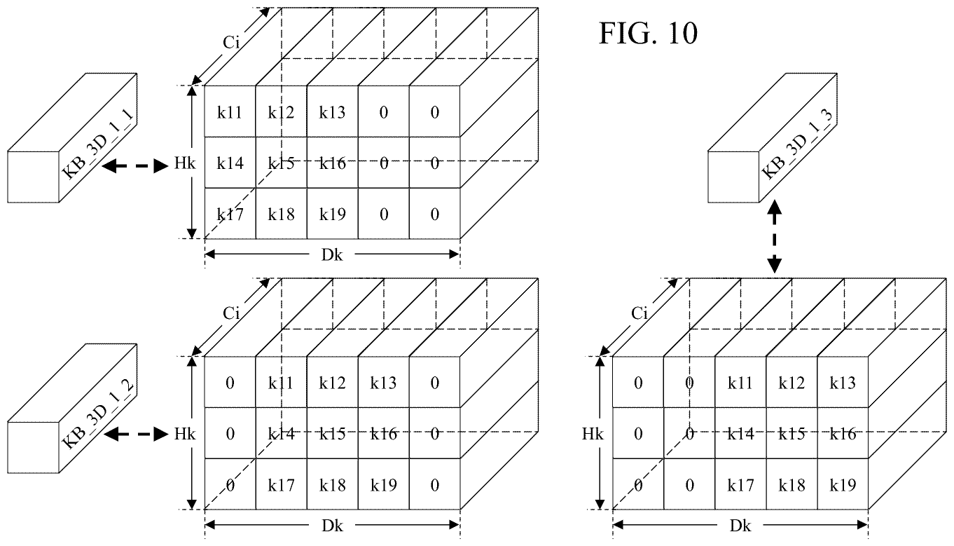

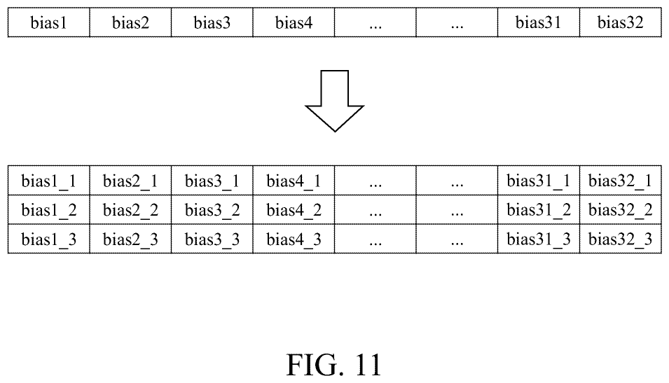

Reference is made to FIG. 10, which shows M of the multiple dilated convolution kernels from FIG. 9. Assuming that the original convolution kernels are as shown in FIG. 3, the multiple M is 3, dilation_w is 1, and stride_w is 1, an original convolution kernel (whose width Wk is 3) in FIG. 3 is dilated into 3 dilated convolution kernels (KB_3D_1_1, KB_3D_1_2, and KB_3D_1_3), and the depth Dk of each dilated convolution kernel is five (referring to Equations (1) and (4)). An original convolution kernel and a dilated convolution kernel have the same height Hk and the same number of channels Ci. Each dilated convolution kernel has the same data, but the arrangement is different; that is, each contains 9 cuboids such as k11, k12, k13, k14, k15, k16, k17, k18, and k19, but the positions of these cuboids are different.
Step S530: Generating multiple biases of the 3D weight KB_3D according to the multiple M and multiple biases of the 2D weight KB_2D. Reference is made to FIG. 11, which is a schematic diagram of the dilation of the biases of the convolution according to an embodiment of the present invention. Continuing the previous example (where the 2D weight KB_2D contains 32 convolution kernels, and the multiple M is 3), before dilation, the 2D weight KB_2D contains 32 biases (bias1, bias2, bias3, bias4, . . . , bias31, and bias32, each bias corresponding to a convolution kernel with the same number). After dilation, the 3D weight KB_3D contains M×32 biases, where biasP_1=biasP_2=biasP_3=biasP (1≤P≤32).
Step S540: Determining multiple parameters (including but not limited to size, stride, and padding value; see Equations (4) to (6)) of the third dimension (e.g., depth) of the 3D weight KB_3D based on the size of the first dimension of the 2D weight, the multiple M, the stride of the first dimension, and the dilation coefficient of the first dimension.

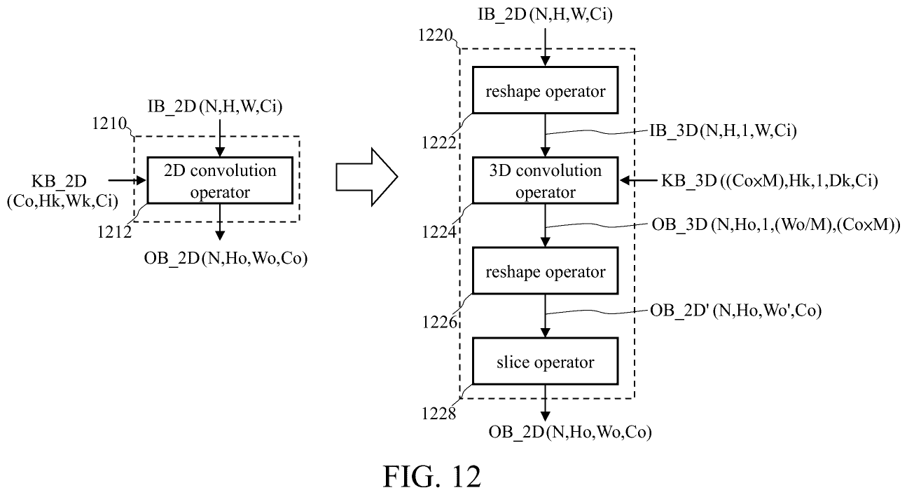

Reference is made to FIG. 12, which is a schematic diagram of the conversion of convolution operation instructions according to an embodiment of the present invention. As shown in FIG. 12, the convolution operation instruction generation device 600 converts the 2D weight KB_2D of a 2D convolution operation instruction 1210 into the 3D weight KB_3D of a 3D convolution operation instruction 1220 according to the above steps. In this way, the original 2D convolution operation (IB_2D*KB 2D) can be converted into a 3D operation (IB_3D*KB_3D). The 2D convolution operation instruction 1210 is used to perform a 2D convolution operation on the input tensor IB_2D and the 2D weight KB_2D and includes the 2D convolution operator 1212. The 3D convolution operation instruction 1220 corresponding to the 2D convolution operation instruction 1210 includes a reshape operator 1222, a 3D convolution operator 1224, a reshape operator 1226, and a slice operator 1228. The 2D convolution operator 1212 performs a 2D convolution operation on an input tensor IB_2D (dimensions: (N,H,W,Ci)) and a 2D weight KB_2D (dimensions: (Co,Hk,Wk,Ci), which includes Co convolution kernels) to produce an output tensor OB_2D (dimensions: (N,Ho,Wo,Co)).

Before the 3D convolution operator 1224, the input tensor IB_2D must be reshaped by the reshape operator 1222 into the 3D input tensor IB_3D (dimensions: (N,H,1,W,Ci)) (i.e., the input tensor IB_3D is the input tensor of the 3D convolution operator 1224). The 2D weight KB_2D is dilated into the 3D weight KB_3D (dimensions: ((Co×M),Hk,1,Dk,Ci), which contains Co×M convolution kernels) according to steps S510 to S540 (i.e., the 3D weight KB_3D is the weight of the 3D convolution operator 1224). Next, the 3D convolution operator 1224 performs a 3D convolution operation on the input tensor IB_3D and the 3D weight KB_3D to generate the output tensor OB_3D (dimensions: (N,Ho,1,(Wo/M),(Co×M))). The reshape operator 1226 reshapes the output tensor OB_3D into the 2D output tensor OB_2D′ (dimensions: (N,Ho,Wo′,Co)). If the width Wo of the output tensor OB_3D is not an integer multiple of M (i.e., Wo′ is not an integer), the slice operator 1228 is needed to slice off the invalid data to obtain the output tensor OB_2D. The invalid data is generated due to the alignment to the multiple M from the result of the 3D convolution operation. If the width Wo of the output tensor OB_3D is an integer multiple of M (i.e., the output tensor OB_2D′ is identical to the output tensor OB_2D), the slice operator 1228 may be omitted.
Step S550: Dividing the input tensors, the convolution kernels, and the biases of the 3D convolution operation into tiles according to the size of the first cache 823. Since the data of convolution operations is usually very large, but the hardware resources of the IPU 820 are limited, the data must be divided. This step is well known to people having ordinary skill in the art, and the details are omitted for brevity.

Reference is made to FIG. 7. The process of FIG. 7 includes the following steps.
Step S710: The first DMA circuit 822 reads data (including, but not limited to, a part of the input tensor (e.g., a tile), a part of the convolution kernel, and/or a part of the bias) from the external memory 802 and writes the data into the first cache 823.
Step S710 includes substep S715: Rearranging the input tensor according to the data arrangement requirement (i.e., reshaping the input tensor, which is to execute the reshape operator 1222). The reshape operation is well known to people having ordinary skill in the art, and the details are omitted for brevity.

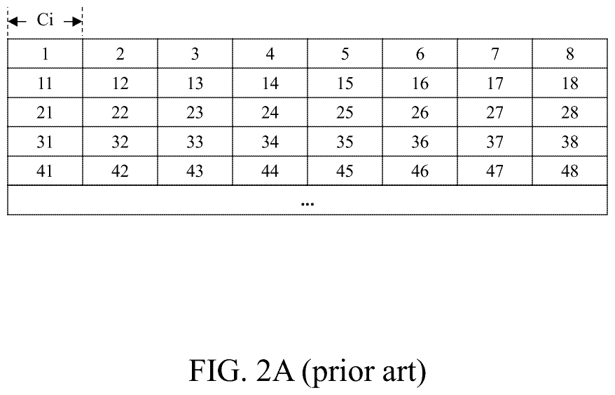

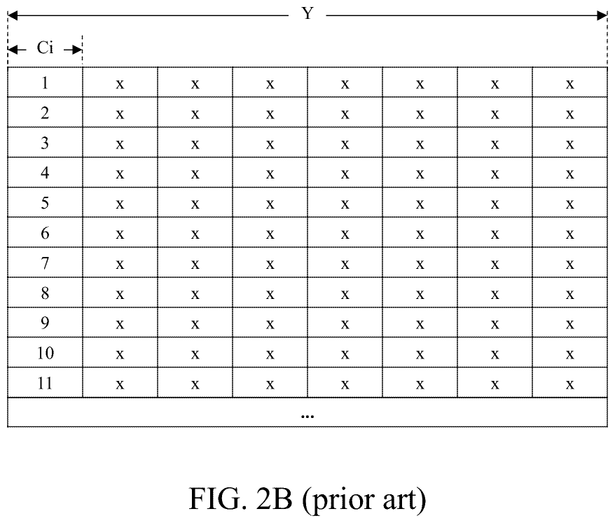

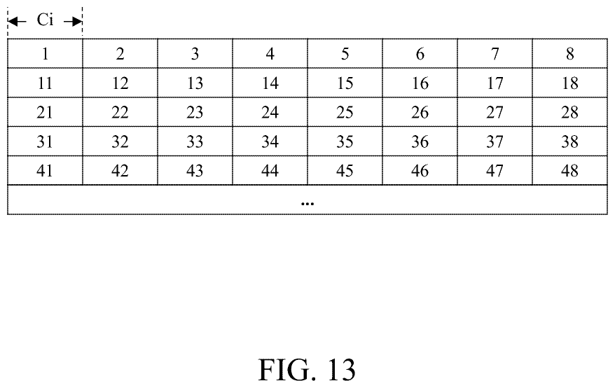

Reference is made to FIG. 13, which is a schematic diagram of the arrangement of the input tensor IB_3D of the 3D convolution operation in the first cache 823 according to the present invention. Although the data has been converted into 3D data, the arrangement of the input tensor IB_3D in the first cache 823 is the same as the prior art in FIG. 2A. However, the IPU 820 may treat the data in FIG. 13 as 3D data according to the parameters of the instruction of the convolution operation.

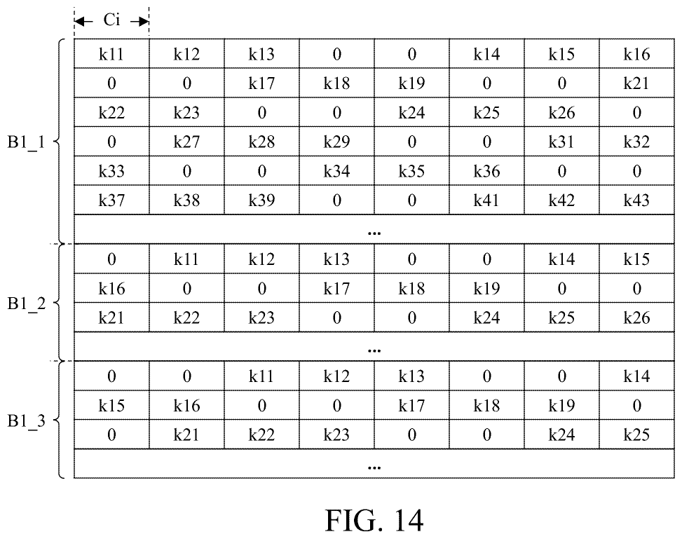

Reference is made to FIG. 14, which is a schematic diagram of the arrangement of the convolution kernels of the 3D convolution operation in the first cache 823 according to the present invention. The blocks B1_1, B1_2, and B1_3 correspond to the first row (KB_3D_1_1, KB_3D_2_1, KB_3D_3_1, . . . , KB_3D_31_1, KB_3D_32_1), the second row (KB_3D_1_2, KB_3D_2_2, KB_3D_3_2, . . . , KB_3D_31_2, KB_3D_32_2), and the third row (KB_3D_1_3, KB_3D_2_3, KB_3D_3_3, . . . , KB_3D_31_3, KB_3D_32_3) of the dilated convolution kernel in FIG. 9, respectively.
Step S720: The second DMA circuit 824 reads the data from the first cache 823 and writes the data into the second cache 825.

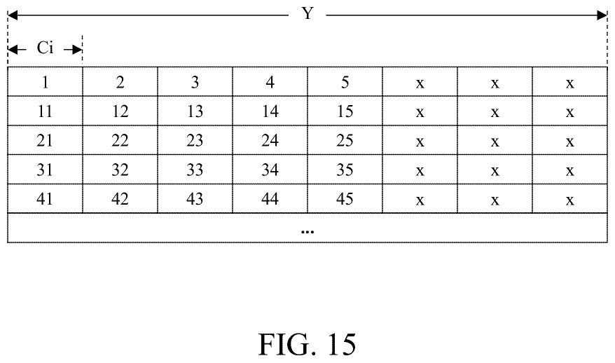

FIG. 15 is a schematic diagram of the arrangement of the input tensors of the 3D convolution operation in the second cache 825 according to the present invention. Compared with FIG. 2B, a row of the second cache 825 stores more valid data, which improves the effective utilization rate of the second cache 825 by the computing circuit 826. More specifically, in the example of FIG. 15, a row contains Dk (which is 5; see FIG. 10) valid data (i.e., the amount of valid data is Dk×Ci=5×Ci elements, which is an equivalent of implementing the accumulation of two dimensions (depth and channel) in the original 2D convolution operation), whereas in FIG. 2B, a row contains only one valid data (i.e., the amount of valid data is 1×Ci elements). In other words, the effective utilization rate of the second cache 825 is increased from Ci/Y to 5×Ci/Y.

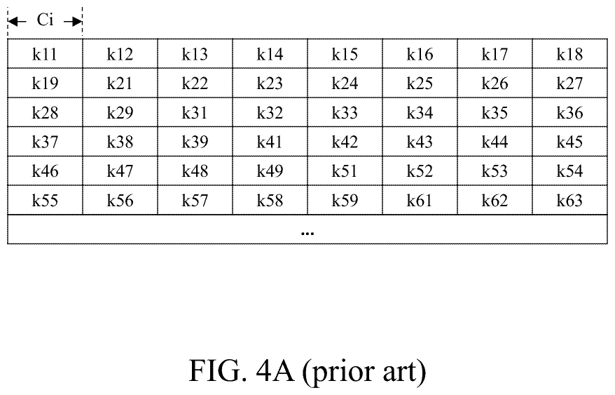

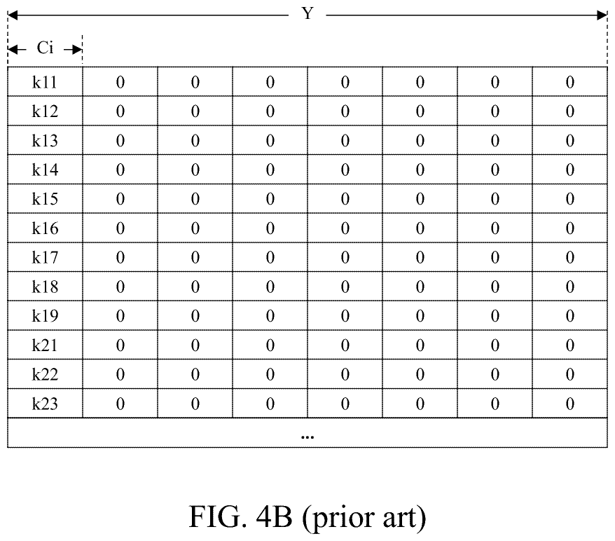

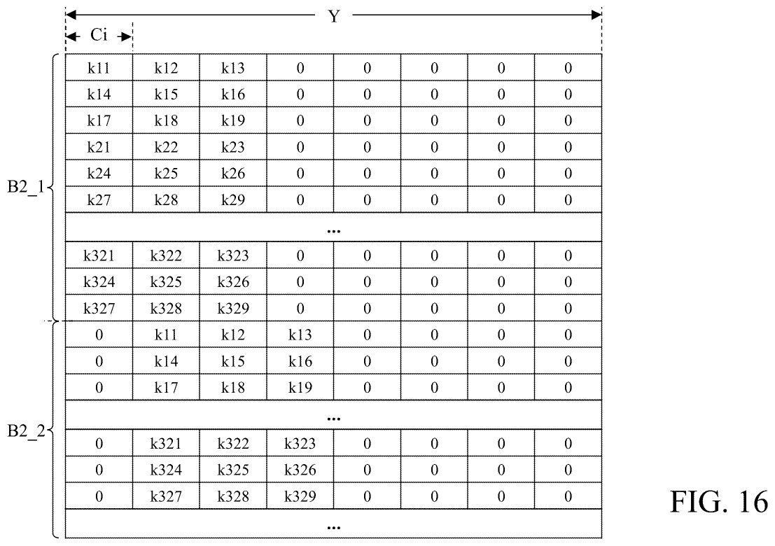

Reference is made to FIG. 16, which is a schematic diagram of the arrangement of the convolution kernels of the 3D convolution operation in the second cache 825 according to the present invention. The block B2_1 and the block B2_2 each contain 32 convolution kernels (referring to FIG. 10, a convolution kernel has 15 cuboids) and correspond to the block B1_1 and the block B1_2 in FIG. 14, respectively. FIG. 16 is for illustration only. In other embodiments, if the second cache 825 is large enough, more convolution kernels (e.g., the convolution kernel corresponding to the block B1_3 in FIG. 14) may be stored. Compared with FIG. 4B, a row of the second cache 825 stores more valid data. More specifically, in the example of FIG. 16, a row contains M (which is 3) valid data (i.e., the amount of valid data is M×Ci=3×Ci elements), whereas a row in FIG. 4B contains only one valid data (i.e., the amount of valid data is 1×Ci elements).
Step S730: The computing circuit 826 (more specifically, the convolution engine 827) reads data from the second cache 825, performs a 3D convolution operation (i.e., executes the 3D convolution operator 1224), and then writes the output tensor OB_3D into the second cache 825. When the computing circuit 826 writes the output tensor OB_3D into the second cache 825, it simultaneously performs a reshape operation on the output tensor OB_3D (i.e., executes the reshape operator 1226 to obtain the output tensor OB_2D′ or OB_2D).
Step S740: The computing circuit 826 determines whether the output tensor needs to be sliced. If YES, the flow proceeds to step S750; otherwise, the flow proceeds to step S760.
Step S750: The computing circuit 826 removes the invalid data (i.e., executes the slice operator 1228). The computing circuit 826 stores the output tensor after slicing back to the second cache 825. As slicing operations are well known to people having ordinary skill in the art, the detailed operation is omitted for brevity.
Step S760: The second DMA circuit 824 reads the output tensor OB_2D from the second cache 825 and writes the output tensor OB_2D into the first cache 823.
Step S770: The first DMA circuit 822 reads the output tensor OB_2D from the first cache 823 and writes the output tensor OB_2D into the external memory 802.
Step S780: The processor 810 determines whether the entire 3D convolution operation is completed. If YES, the process of FIG. 7 ends; otherwise, the flow proceeds to step S710 to process the next tile.

In summary, the present invention converts the first dimension (width) of the 2D convolution operation to the third dimension (depth) of the 3D convolution operation. Because the 3D convolution operation performs accumulation in the second dimension (channel) and the third dimension (depth), the above conversion is equivalent to performing the accumulation in the first dimension (width) and the second dimension (channel) of the original 2D convolution operation. Reference is made to FIGS. 15 and 16. In the 3D convolution operation, when calculating each value of the output tensor, the input tensors and the Y elements in the rows corresponding to a convolution kernel are multiplied and added, respectively. This multiply-accumulate operation is performed for three rows of data, and then a bias is added to obtain the final result. In contrast (see FIG. 2B and FIG. 4B), the 2D convolution operation requires multiply-accumulate operations on nine rows of data to obtain a final result. Therefore, the efficiency of the convolution operation in this invention is increased by M times (which is equal to 9/3=3).

In addition, reference is made to FIG. 4B and FIG. 16. In comparison with the 2D convolution operation, in the 3D convolution operation, a row of the second cache 825 stores M times the convolution kernel data; therefore, the input tensors in each row of the second cache 825 (e.g., a row of data in FIG. 15) is used M times, reducing the bandwidth requirement for the second cache 825.

The present invention also optimizes the read operation of the convolution kernel. Reference is made to FIG. 9 and FIG. 10. Although a convolution kernel is dilated into M convolution kernels, the data of the M convolution kernels are substantially the same (containing substantially the same cuboids). Therefore, the second DMA circuit 824 may read only one of the M convolution kernels and use the shifting operation to create the remaining M−1 convolution kernels to save bandwidth. In an alternative embodiment, the shifting operation may be performed by the computing circuit 826 (more specifically, the vector engine 828).

The aforementioned descriptions represent merely the preferred embodiments of the present invention, without any intention to limit the scope of the present invention thereto. Various equivalent changes, alterations, or modifications based on the claims of the present invention are all consequently viewed as being embraced by the scope of the present invention.

What is claimed is:

1. A convolution operation instruction generation device for generating a second convolution operation instruction based on a first convolution operation instruction, wherein the first convolution operation instruction is for performing a two-dimensional (2D) convolution operation on a first input tensor and a first weight, the second convolution operation instruction comprises a three-dimensional (3D) convolution operator and is executed by an intelligence processing unit (IPU) comprising a storage device and a computing circuit, and the computing circuit accesses the storage device in units of Y elements, the convolution operation instruction generation device comprising:
a memory configured to store a plurality of program codes and/or program instructions; and
a processor coupled to the memory and configured to execute the plurality of program codes and/or program instructions to perform following steps:
(A) calculating a multiple according to Y, a size of a first dimension of the first weight, a size of a second dimension of the first weight, a dilation coefficient of the first dimension, and a first stride of the first dimension;
(B) generating a second weight of the 3D convolution operator according to the multiple and the first weight;
(C) generating a plurality of second biases of the second weight according to the multiple and a plurality of first biases of the first weight; and
(D) determining a size of a third dimension of the second weight, a second stride of the third dimension, and a padding value of the third dimension according to a size of the first dimension, the multiple, the first stride, and the dilation coefficient.

2. The convolution operation instruction generation device of claim 1, wherein the multiple is an integer greater than or equal to two.

3. The convolution operation instruction generation device of claim 2, wherein the multiple is less than a maximum value of a variable t, the variable t satisfies an equation: Y≥[Wk+(Wk−1)×(dilation_w−1)+t×stride_w]×Ci, where Wk is the size of the first dimension, dilation_w is the dilation coefficient of the first dimension, stride_w is the first stride of the first dimension, and Ci is a size of the second dimension.

4. The convolution operation instruction generation device of claim 1, wherein the second convolution operation instruction further comprises a reshape operator, the IPU executes the reshape operator before executing the 3D convolution operator to convert the first input tensor into a second input tensor, and the 3D convolution operator performs a 3D convolution operation on the second input tensor and the second weight.

5. The convolution operation instruction generation device of claim 4, wherein the reshape operator is a first reshape operator, the second convolution operation instruction further comprises a second reshape operator, the 3D convolution operation generates a first output tensor, and the IPU further performs the second reshape operator to convert the first output tensor into a second output tensor.

6. The convolution operation instruction generation device of claim 1, wherein a size of the first dimension of the second weight is equal to one.

7. The convolution operation instruction generation device of claim 6, wherein the size of the third dimension of the second weight is Wk+(Wk−1)×(dilation_w−1)+(M−1)×stride_w, where Wk is the size of the first dimension, dilation_w is the dilation coefficient of the first dimension, stride_w is the first stride of the first dimension, and M is the multiple.

8. The convolution operation instruction generation device of claim 1, wherein a size of the second dimension of the second weight is equal to the size of the second dimension of the first weight.

9. The convolution operation instruction generation device of claim 1, wherein the first weight comprises R first convolution kernels, and the second weight comprises R×M second convolution kernels, where R is a positive integer, and M is the multiple.

10. The convolution operation instruction generation device of claim 1, wherein the second stride of the third dimension is M×stride_w, where M is the multiple, and stride_w is the first stride of the first dimension.

11. A convolution operation method executed by an intelligence processing unit (IPU) comprising a first storage device, a second storage device, and a computing circuit, the computing circuit accessing the second storage device in units of Y elements and performing a three-dimensional (3D) convolution operation on an input tensor and a 3D weight, and a size of a first dimension of the input tensor being a value, the convolution operation method comprising:
reading a part of the input tensor and a part of the 3D weight from the first storage device, and writing the part of the input tensor and the part of the 3D weight into the second storage device, wherein an effective data amount of Y consecutive elements in the second storage device is greater than the value;
reading the part of the input tensor and the part of the 3D weight from the second storage device, and performing the 3D convolution operation to generate an output tensor;
writing the output tensor to the second storage device; and
reading the output tensor from the second storage device, and writing the output tensor into the first storage device.

12. The convolution operation method of claim 11, wherein a size of the first dimension of the 3D weight is the value.

13. The convolution operation method of claim 11, wherein the output tensor is a 3D tensor, the convolution operation method further comprising:
performing a reshape operation on the output tensor to generate a two-dimensional (2D) output tensor.

14. The convolution operation method of claim 13, wherein the convolution operation method further comprises:
performing a slicing operation on the 2D output tensor when any dimension of the 2D output tensor is not an integer, so that all dimensions of the 2D output tensor are integers.

15. The convolution operation method of claim 11, wherein the effective data amount is a product of a size of a second dimension of the 3D weight and the value.

16. An intelligence processing unit (IPU) performing a three-dimensional (3D) convolution operation on an input tensor and a 3D weight, a size of a first dimension of the input tensor being a value, the IPU comprising:
a first storage device configured to store a part of the input tensor and a part of the 3D weight;
a second storage device;
a direct memory access (DMA) circuit coupled to the first storage device and the second storage device and configured to read the part of the input tensor and the part of the 3D weight from the first storage device and write the part of the input tensor and the part of the 3D weight into the second storage device, wherein an effective data amount of Y consecutive elements in the second storage device is greater than the value; and
a computing circuit coupled to the second storage device and configured to perform following steps:
reading the part of the input tensor and the part of the 3D weight from the second storage device, and performing the 3D convolution operation to generate an output tensor; and
writing the output tensor to the second storage device;
wherein the DMA circuit further reads the output tensor from the second storage device and writes the output tensor into the first storage device.

17. The IPU of claim 16, wherein a size of the first dimension of the 3D weight is the value.

18. The IPU of claim 16, wherein the output tensor is a 3D tensor, the computing circuit performs a reshape operation on the output tensor when writing the output tensor into the second storage device, so as to generate a two-dimensional (2D) output tensor.

19. The IPU of claim 18, wherein the DMA circuit is a first DMA circuit, the IPU further comprises a second DMA circuit and is coupled to an external memory, and the second DMA circuit performs following steps:
performing a slicing operation on the 2D output tensor when any dimension of the 2D output tensor is not an integer, so that all dimensions of the 2D output tensor are integers; and
writing the 2D output tensor into the external memory.

20. The IPU of claim 16, wherein the effective data amount is a product of a size of a second dimension of the 3D weight and the value.
